(19) United States
(12) Patent Application Publication
(10) Pub. No.: US 2011/0143151 A1
(43) Pub. Date: Jun. 16, 2011

(54) MANUFACTURING METHOD FOR A FILM-ATTACHED METAL PLATE AND THE STRUCTURE THEREOF, AND A CAN STRUCTURE

(75) Inventor: Tsuan-I Chang, Taipei (TW)

(73) Assignee: GOOD TORCH ENTERPRISE CORP., TAIPEI (TW)

(21) Appl. No.: 12/635,448

(22) Filed: Dec. 10, 2009

(51) Int. Cl. B32B 15/095; B32B 37/00; B32B 38/14

(52) U.S. Cl. 428/457; 156/60; 156/277; 156/331.7

(57) ABSTRACT

A manufacturing method for a film-attached metal plate includes the steps of: providing a copolymer film, and disposing a glue on the copolymer with a predetermined density, and then forming a gluing layer on the copolymer film; providing a metal plate; and laminating the copolymer film with the gluing layer on the metal plate so as to form the film-attached metal plate. Herein, the copolymer film further has patterns thereon by a printing step; therefore, the film-attached metal plate can present colors or/and patterns.

### BACKGROUND OF THE INVENTION

1. Field of the Invention

The present invention is an apparatus which relates to a manufacturing method for a film-attached metal plate and the structure thereof, and further to a can structure which is made from the film-attached metal plate; especially, the present invention relates to a manufacturing method for a film-attached metal plate with lower energy consumption, and to a film-attached metal plate and a can structure with reliable attachment.

2. Description of Related Art

Metal cans such as food cans, chemical cans are made from metal thin plate of tin plate. The tin plate has patterns and words on the surfaces thereof by a printing method. The traditional method includes the steps: coating a base layer on the upper surface of the tin plate and then baking the tin plate; printing the colorful patterns on the base layer and then baking the tin plate; coating the rust prevention layer on the back surface of the tin plate and then baking the tin plate. At last, the tin plate is formed into the cans.

The above-mentioned traditional method is applied for a single tin plate and is not suitable to the wounded plate for continuous manufacturing processes. Thus the traditional method has disadvantages of low manufacturing rate, low efficiency and high manufacturing cost. On the other hand, the surface of the tin plate is too smooth (i.e. with no capillary hole) to penetrate water and solvent. Thus, it is necessary to heat the tin plate for volatilizing the solvent in the ink and paint. For example, the tin plate is baked at 180° C. in 20 minutes so that the baking step costs a lot of energy. Especially, the drying rate of the ink and paint has to be precisely controlled to print the patterns on the tin plate. The problems of failure of printing, attachment of particles, low adhesion and low attachment are resulted from the higher or lower drying rate of the ink and paint. Therefore, it causes the surface scratch on the printed tin plates.

To sum up, there are three to six times of the baking processes so that it costs a lot of energy and release much waste gas. Furthermore, the printed pattern layer will be degenerated due to the high temperature baking. Therefore, the saturation of the colors is decreased, and the range of the colors is decreased. In other words, the quality of the printed colors is lowered.

Another traditional method is coating glue on the metal plate and then laminating a printed film on the metal plate. However, it is necessary to heat the metal plate and the printed film to 150 to 180° C. Thus, the problem of the high energy-consumption cannot be solved by this method.

Consequently, with regard to the resolution of defects illustrated hereinbefore, the inventors of the present invention propose a reasonably designed solution for effectively eliminating such defects.

### SUMMARY OF THE INVENTION

The objective of the present invention is to provide a manufacturing method for a film-attached metal plate characterized in continuous processes, high production rate, low manufacturing cost and low energy consumption.

To achieve the objective described as above, the present invention discloses a manufacturing method for a film-attached metal plate, including the steps of: providing a copolymer film, and disposing a glue on the copolymer with a predetermined density, and then forming a gluing layer on the copolymer film; providing a metal plate; and laminating the copolymer film with the gluing layer on the metal plate so as to form the film-attached metal plate. Herein, the copolymer film further has patterns thereon by a printing step; therefore, the film-attached metal plate can present colors or/and patterns.

The present invention further discloses a film-attached metal plate including a metal plate having a surface laminating with a copolymer film by a gluing layer. The gluing layer is formed by spraying, roll-spreading, or coating a glue on the copolymer film with a predetermined density.

The present invention still further discloses a can structure formed by connecting two opposite ends of a film-attached metal plate. The film-attached metal plate including a metal plate having a surface laminating with a copolymer film by a gluing layer. The gluing layer is formed by spraying, roll-spreading, or coating a glue on the copolymer film with a predetermined density. The metal plate and the copolymer film attached on the metal plate are integrally formed as the can structure with a circular shape, a rectangle shape, a non-regular-shape, or a two-piece can. The non-regular-shaped can is a triangle can, a pentagon can, a hexagon can, a octagon can, a sectors-shaped can, a curved can, a spray can, or a chemical can

The present invention provides the following beneficial effects: the glue is coated on the copolymer film in a predetermined density so that the copolymer can be attached with the film metal plate in a low temperature and in a shorter period. Therefore, the traditional method with multi-time and multi-baking process can be replaced. The energy-consumption is reduced and the film-attached metal plate of the present invention has properties of high anti-corrosion, high stability and reliable attachment.

In order to further appreciate the characteristics and technical contents of the present invention, references are hereunder made to the detailed descriptions and appended drawings in connection with the present invention. However, the appended drawings are merely shown for exemplary purposes, rather than being used to restrict the scope of the present invention.

### BRIEF DESCRIPTION OF THE DRAWINGS

FIG. 1 is a flow chart of the manufacturing method for a film-attached metal plate according to the present invention.

FIG. 2 is a structural diagram of the manufacturing method for a film-attached metal plate according to the present invention.

FIG. 3 is a diagram of the film-attached metal plate according to the present invention.

FIG. 4 is a structural diagram of the film-attached metal plate according to the present invention.

FIG. 4A is a structural diagram of the film-attached metal plate according to the second embodiment of the present invention.

FIG. 5 is a structural diagram of the can structure according to the present invention.

### DETAILED DESCRIPTION OF THE PREFERRED EMBODIMENTS

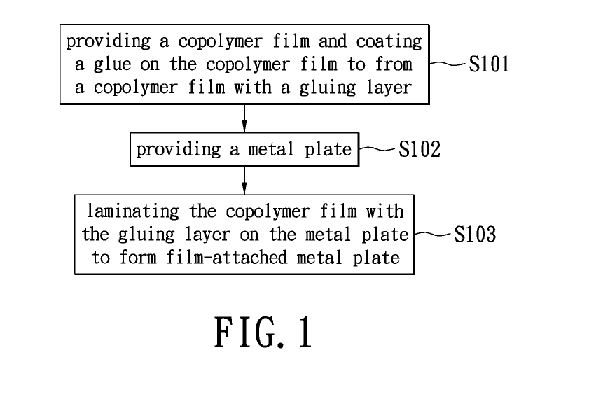

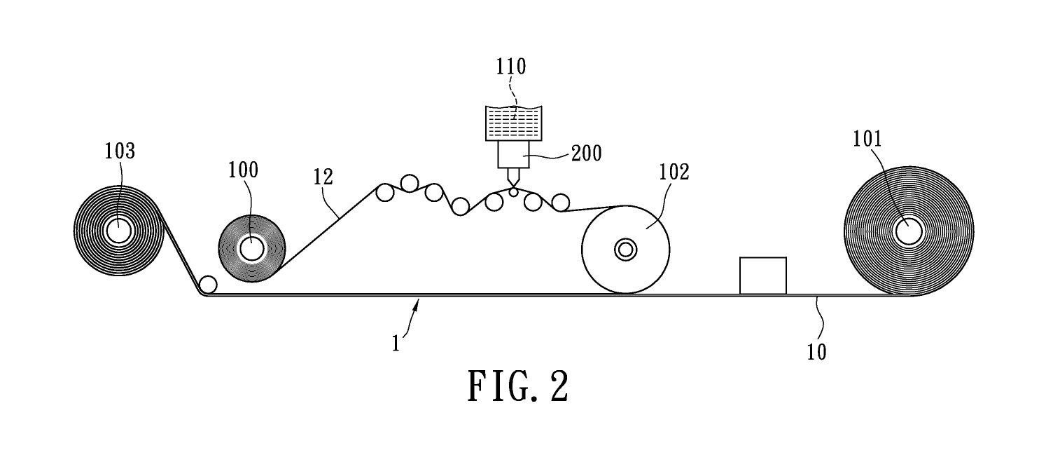

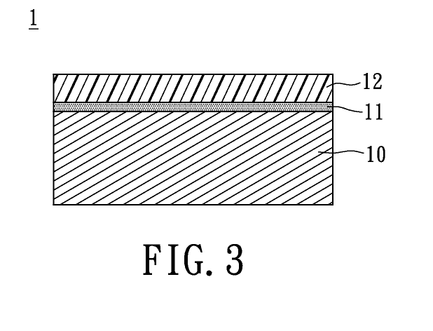

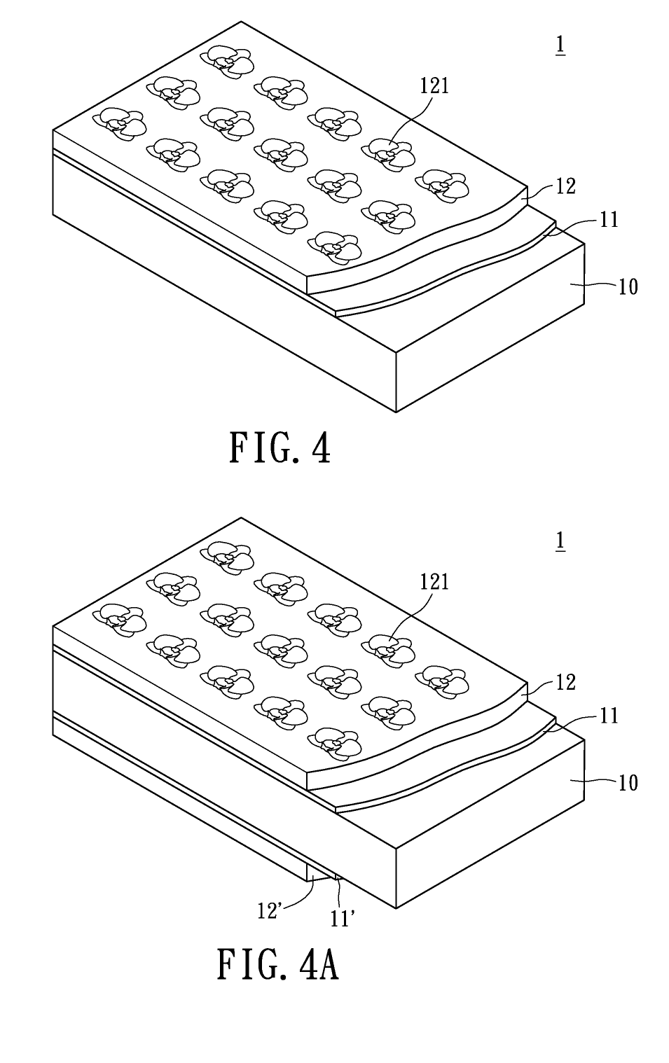

Refer now to FIGS. 1 and 2; the first present invention provides a manufacturing method for a film-attached metal plate. The manufacturing method has high efficiency for fabricating the film-attached metal plate, and the manufactured film-attached metal plate has properties of high stability and high wear resistance. The manufacturing method has the following steps (please refer to FIGS. 3 to 4).

Step S101 is providing a copolymer film 12, and the copolymer film 12 is coated with glue 110 by a spraying method, a roll-spreading method, or a coating method. The glue 110 is cured on the copolymer film 12 so that the copolymer film 12 with a gluing layer 11 is formed. FIG. 2 shows the embodiment of the present invention and the manufacturing method is used for laminating the copolymer film 12 on a metal plate 10 by using rollers. The copolymer film 12 is driven by the first roller 100, and the copolymer film 12 can be a PET file, a PP film, or another high polymer film. The thickness of the copolymer film 12 is ranged between 15 um and 25 um. The glue 110 is uniformly coated on the copolymer film 12 by the coating device 200. The coating device 200 can be a spraying apparatus, a roll-spreading apparatus, or another coating apparatus, and the glue 110 is solvent-based glue, or polyurethane reactive (PUR) hot melt adhesive glue.

The glue 110 is disposed on the copolymer film 12 with a predetermined density by the coating device 200 so as to form the gluing layer 11 on the copolymer film 12. The predetermined density is ranged from 7 to 12 grams per square meter, and preferably the predetermined density is ranged from 8 to 10 grams per square meter. By adjusting the density of the glue 110, the issues of the defects or bubbles generated in the laminating step can be avoided.

On the other hand, patterns 121 can be printed on the surface of the copolymer film 12 before coating the glue 110 on the copolymer film 12. For example, the patterns 121 are printed on the copolymer film 12 in the printing step by a gravure printing method. The patterns 121 can have various colors or metal shade, for example, a laser anti-fake label can be printed on the copolymer film 12. In the embodiment, the patterns 121 can be printed on the surface of the copolymer film 12 by a color-printing method and eight to ten colors can be printed at one step. In addition, the copolymer film 12 of 100 to 200 m can be printed in one minutes and the maximum width of the copolymer film 12 is about 1.2 m.

Step S102 is providing a metal plate 10. Please refer to FIG. 2; the metal plate 10 is driven by the second roller 101. The metal plate 10 is a tinned-iron plate, chromium-plated-iron plate, non-coated-iron plate, or galvanized-iron plate.

Step S103 is laminating the copolymer film 12 with the gluing layer 11 on the metal plate 10. In the step, a pressing force is provided by the pressing roller 102 to press and attach the copolymer film 12 on the metal plate 10, and the copolymer film 12 is fixed on the metal plate 10 via the uniform gluing layer 11 to construct the film-attached metal plate 1. Furthermore, the copolymer film 12 is attached on the metal plate 10 at the temperature equal to or lower than 100° C. Therefore, it is not necessary to heat the metal plate 10 in a high temperature in the method of the present invention. A lower temperature (100° C.) and a short heating time (few seconds) are provided for laminating the copolymer film 12 and the metal plate 10 so that the effect of the saving energy can achieved. In the embodiment, the laminating temperature can be provided by the pressing roller 102 so as to attach the copolymer film 12 and the metal plate 10 to construct the film-attached metal plate 1 with high structure strength. Furthermore, the laminating rate of the copolymer film 12 and the metal plate 10 can be 40 to 60 m per minutes.

At last, the manufactured film-attached metal plate 1 is wounded by the roller 103.

Please refer to FIGS. 3 and 4; the film-attached metal plate 1 has a metal plate 10 and the metal plate 10 has a copolymer film 12 attached on a surface thereof by a gluing layer 11. The gluing layer 11 is formed by spraying, roll-spreading, or coating the glue 110 on the copolymer film 12 with a predetermined density. Moreover, the gluing layer 11 and the copolymer film 12 can attached on both surfaces of the metal plate 10, as the gluing layer 11′ and the rust prevention film 12′ shown in FIG. 4A. Therefore, one surface of the metal plate 10 has visual printing effect and the other surface of the metal plate 10 has rust prevention effect. In other words, the back surface of the metal plate 10 can have another copolymer film 12 (i.e., rust prevention film 12′) by the similar method including the above-mentioned steps.

On the other hand, the attached copolymer film 12 can have patterns 121 to show the attractive drawings and colors.

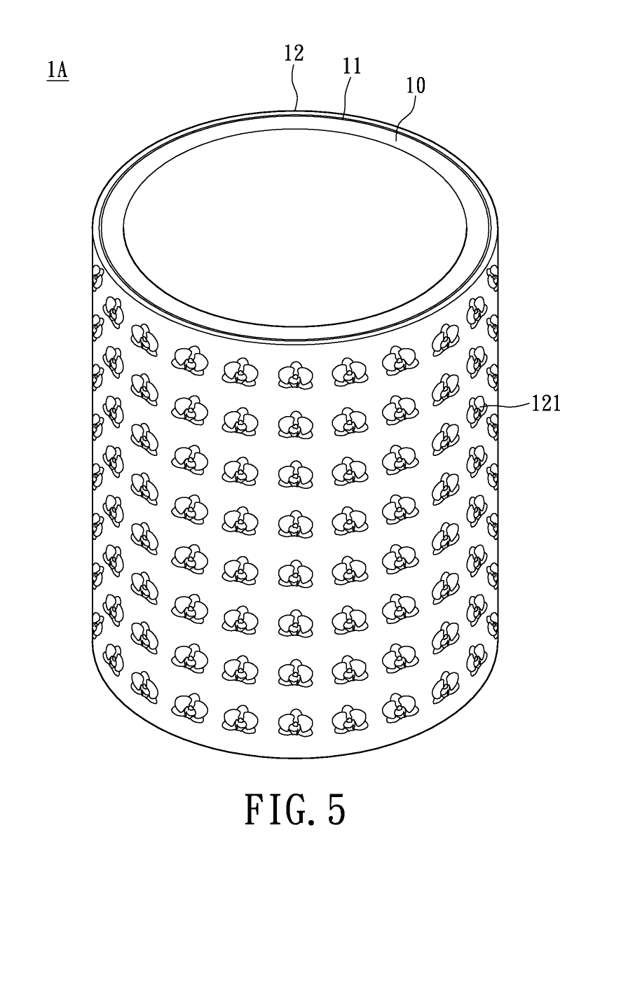

Please refer to FIG. 5; the manufactured film-attached metal plate 1 can be used for fabricating the can structure 1A. After separating the wounded film-attached metal plate 1, the film-attached metal plate 1 can be constructed as the can structure 1A by a pressing method. Two ends of the film-attached metal plate 1 are connected together to form the can structure 1A. In the formation step, the copolymer film 12 is fixed with the metal plate 10 firmly, and the metal plate 10 and the copolymer film 12 are integrally formed as the can structure 1A. The can structure 1A can have various shapes, such as circular, rectangle, or non-regular shapes, or the can structure 1A can be a two-piece can. The non-regular shapes means the shapes other than circular and rectangle shapes, such as triangle, pentagon, hexagon, octagon, sector, or curved shapes. The can structure 1A can be used for a spray can, or a chemical can.

In summary of aforementioned descriptions, the present invention can provide the following advantages:

1. The wounded metal plate and the printed copolymer film are attached with each other to form the film-attached metal plate, and then the fabricated film-attached metal plate are separated in pieces so as to form as a can structure. Therefore, the film-attached metal plate and the can structure are manufactured by automatic manufacturing processes so that the advantages of high manufacturing efficiency, high quality, low energy-consumption, and low material-loss. Furthermore, the labor safety is improved.

2. The glue used in the laminating step of the present invention does not release the exhaust gas so that the attachment quality is improved (i.e., no bubbles between the copolymer film and the metal plate) and the process is meet the requirement of the environmental protection. Furthermore, it is not necessary to heat the materials in high temperature, therefore, the energy consumption and the manufacturing cost can be reduced. For example, printing/drying equipment with length of 50 m is necessary in the traditional iron-print method. The temperature of the equipment is remained about 180° C. Therefore, it costs much energy (about 420 thousands Kcal per hour) to heat the equipment. On the contrary, the manufacturing method of the present invention is provided for laminating the copolymer film on the metal plate in one working time and the laminating rate is higher. In addition, it is not necessary to provide the high temperature (about 180° C.) in long period (about 20 minutes) to attach the copolymer film on the metal plate. Accordingly, the energy consumption is reduced and 70% of energy is saved.

3. The film-attached metal plate has properties of anti corrosion due to the attached copolymer film. Furthermore, the film-attached metal plate has improved elongation and can be formed by a high pressing forming process. Therefore, the film-attached metal plate of the present invention is suitable for food cans, chemical cans, two-piece can, or cans of another application.

The texts set forth hereinbefore illustrate simply the preferred embodiments of the present invention, rather than intending to restrict the scope of the present invention claimed to be legally protected thereto. All effectively equivalent changes made by using the contents of the present disclosure and appended drawings thereof are included within the scope of the present invention delineated by the following claims.

What is claimed is:

1. A manufacturing method for a film-attached metal plate, comprising steps of:
providing a copolymer film, and disposing a glue on the copolymer with a predetermined density, and then forming a gluing layer on the copolymer film;
providing a metal plate; and
laminating the copolymer film with the gluing layer on the metal plate so as to form the film-attached metal plate.

2. The manufacturing method for a film-attached metal plate according to claim 1, further comprising a printing step before the step of coating the glue on the copolymer film to print patterns on the copolymer film in the printing step.

3. The manufacturing method for a film-attached metal plate according to claim 2, wherein the patterns are printed on the copolymer film in the printing step by a gravure printing method.

4. The manufacturing method for a film-attached metal plate according to claim 1, wherein the glue is sprayed, roll-spread, or coated on the copolymer film with the predetermined density of 7 to 12 grams per square meter.

5. The manufacturing method for a film-attached metal plate according to claim 4, wherein the copolymer film is sprayed, roll-spread, or coated with the glue with the predetermined density of 8 to 10 grams per square meter.

6. The manufacturing method for a film-attached metal plate according to claim 1, wherein the copolymer film is sprayed, roll-spread, or coated with the glue with the predetermined density of 7 to 12 grams per square meter.

7. The manufacturing method for a film-attached metal plate according to claim 1, wherein in the step of laminating the copolymer film with the gluing layer on the metal plate, the copolymer film with the gluing layer is attached on the metal plate in a temperature equal to or lower than 100° C.

8. The manufacturing method for a film-attached metal plate according to claim 1, wherein the copolymer film is a PET file or a PP film, and the metal plate is a tinned-iron plate, chromium-plated-iron plate, non-coated-iron plate, or galvanized-iron plate.

9. The manufacturing method for a film-attached metal plate according to claim 1, wherein the glue is a solvent-based glue, or a polyurethane reactive hot melt adhesive glue.

10. A film-attached metal plate, comprising:
a metal plate having a surface laminating with a copolymer film by a gluing layer, the gluing layer being formed by spraying, roll-spreading, or coating a glue on the copolymer film with a predetermined density.

11. The film-attached metal plate according to claim 10, wherein the copolymer film is sprayed, roll-spread, or coated with the glue with the predetermined density of 7 to 12 grams per square meter.

12. The film-attached metal plate according to claim 11, wherein the copolymer film is sprayed, roll-spread, or coated with the glue with the predetermined density of 8 to 10 grams per square meter.

13. The film-attached metal plate according to claim 10, wherein the copolymer film is a PET file or a PP film, and the metal plate is a tinned-iron plate, chromium-plated-iron plate, non-coated-iron plate, or galvanized-iron plate.

14. The film-attached metal plate according to claim 10, wherein the glue is a solvent-based glue, or a polyurethane reactive hot melt adhesive glue.

15. A can structure formed by connecting two opposite ends of a film-attached metal plate, the film-attached metal plate comprising a metal plate having a surface laminating with a copolymer film by a gluing layer, the gluing layer being formed by spraying, roll-spreading, or coating a glue on the copolymer film with a predetermined density, wherein the metal plate and the copolymer film attached on the metal plate are integrally formed as the can structure, the can structure is a circular-shaped can, a rectangle-shaped can, a non-regular-shaped can, or a two-piece can, and the non-regular-shaped can is a triangle can, a pentagon can, a hexagon can, a octagon can, a sectors-shaped can, a curved can, a spray can, or a chemical can.

16. The can structure according to claim 15, wherein the copolymer film is sprayed, roll-spread, or coated with the glue with the predetermined density of 7 to 12 grams per square meter.

17. The can structure according to claim 16, wherein the copolymer film is sprayed, roll-spread, or coated with the glue with the predetermined density of 8 to 10 grams per square meter.

18. The can structure according to claim 15, wherein the copolymer film is a PET file or a PP film, and the metal plate is a tinned-iron plate, chromium-plated-iron plate, non-coated-iron plate, or galvanized-iron plate.

19. The can structure according to claim 15, wherein the glue is a solvent-based glue, or a polyurethane reactive hot melt adhesive glue.

20. The can structure according to claim 15, wherein the can structure has various shapes, the can structure is a circular-shaped can, a rectangle-shaped can, a non-regular-shaped can, or two-piece can, and the non-regular-shaped can is a triangle can, a pentagon can, a hexagon can, a octagon can, a sectors-shaped can, a curved can, a spray can, or a chemical can.
